(19) United States
(12) Patent Application Publication
(10) Pub. No.: US 2015/0161504 A1
(43) Pub. Date: Jun. 11, 2015

(54) Personal Can Counter

(71) Applicant: Tim Scott, Canaseraga, NY (US)

(72) Inventor: Tim Scott, Canaseraga, NY (US)

(21) Appl. No.: 14/548,253

(22) Filed: Nov. 19, 2014

Related U.S. Application Data
(60) Provisional application No. 61/906,229, filed on Nov. 19, 2013.

(51) Int. Cl. G06M 1/08; G06M 1/24

(52) U.S. Cl. CPC G06M 1/086; G06M 1/241

(57) ABSTRACT

The present invention relates to a device for the counting of cans and bottles as they are deposited into a receptacle. The device comprises an adjustable means for attaching onto a trash receptacle and hold the same above the receptacle in order to deposit cans and bottles through the device and thereafter within the receptacle. Further, a counter is provided for numerically representing each can or bottle deposited within the receptacle. When the trashcan or bin is full or ready to be emptied, an individual can view the counter in order to know how many cans or bottles are contained within the receptacle prior to recycling. The device, therefore, offers a convenient way to count deposited bottles, eliminates the need to manually count bottles, and offers a practical way to encourage people to recycle.

### CROSS REFERENCE TO RELATED APPLICATION

This application claims the benefit of U.S. Provisional Application No. 61/906,229 filed on Nov. 19, 2013, entitled “Personal Can Counter.” The above identified patent application is herein incorporated by reference in its entirety to provide continuity of disclosure.

### BACKGROUND OF THE INVENTION

1. Field of the Invention

The present invention relates to a device for counting cans and bottles within a trash receptacle. More specifically, the invention relates to a device comprising an opening sized for receiving bottles and cans therein, whereby each item passed through the opening is recorded and displayed on a counter.

Aluminum cans and bottles are valued because they provide a convenient means for storing liquids and food products for an extended period of time. Because of this, these containers are utilized often and can contribute to waste in landfills. The bottles and cans, however, are recyclable and therefore there is a need to provide a means for encouraging an individual to recycle. This is of the utmost importance because on average a can is about 68% recyclable and as a whole only about 69% of cans worldwide are recycled, thereby unnecessarily contributing to waste.

There are several methods of encouraging individuals to recycle. Some methods involve advertising on the recyclability of bottles and cans, dedicated recycling receptacles in public areas, and programs that financially reward individuals for recycling. Each method of providing recycling awareness provides a means for enabling individuals to recycle, however, these methods fail to promote awareness in the home and others, such as financial reward methods, are only offered in a limited locations. There are, however, only a limited amount of devices that encourage recycling.

Of the devices that attempt to encourage recycling, several of them involve dedicated containers for recycling. Some of these devices can include receptacles with separate compartments and a lid comprising a hole for each compartment, whereby each compartment is intended for receiving trash, bottles, cans, or paper therein in order to provide organization for recycling. Other devices can include can/bottle counters that enable an individual to keep track of the amount of bottles and/or cans within a recycling container. Some of the can counting devices can further include a means for dispensing a monetary amount that corresponds to the amount of recycled product.

The drawbacks of these devices, however, are that they are not suitable for use within the home. These devices are often large and are designed for use in public places or within recycling centers. Further, the dedicated recycling containers must be bought separately for use in a home, and therefore require additional space. Therefore, there is a need for a recycling encouraging device that can be utilized in a home without requiring the purchase of a separate receptacle.

The present invention relates to a new and improved means for counting recycled bottles and cans within a home or public setting. The device includes a plate with a throughway opening for receiving bottles and/or cans and a pair of extendable and retractable side arms for placement on a receptacle. The device further includes a counter with an actuator positioned beneath the opening of the plate, whereby as each item passes through the opening it comes into contact with the actuator and causes the counter to advance forward one digit. Further, the device includes a reset button for returning the count to zero in preparation of starting a new count after the trash or recycling container is emptied.

2. Description of the Prior Art

Devices have been disclosed in the prior art that relate to recycling containers. These include devices that have been patented and published in patent application publications. These devices generally relate to containers including a counting means. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,887,696 to Goetz provides an aluminum can recycling center that receives cans from individual consumers and prepares the cans for recycling by sorting the cans and crushing the cans. Further, the device is designed for dispensing a monetary amount to the consumer that equals the deposited can amount. However, the device of Goetz, fails to provide a can counter that can be utilized with existing trash and recycling receptacles, which is provided by the present invention.

U.S. Pat. No. 4,472,819 to Constantino discloses an apparatus for receiving, counting, and compensating an individual for deposited cans. The device further includes a means for sorting between aluminum and steel cans and also pays a consumer for the deposited cans. The device, however, comprises a large, stand-alone housing that is not capable of being placed over an existing receptacle, thereby preventing convenient use in the home or office.

Another patented device, U.S. Pat. No. 4,731,802 to Magnusson provides a device for counting substantially cylindrical articles. The device includes a housing with a rotatable elevator cylinder with a series of compartments for receiving the articles therein. Further, the device includes sensors for identifying objects in each compartment and a means for counting the number of objects in the device. Although Magnusson discloses a counting device, Magnusson fails to provide a means for attachment onto existing receptacles and therefore is not capable of use within the home.

Yet another device, U.S. Pat. No. 4,324,325 to Dewoolfson provides a device for collecting metal containers. The device includes a rotating belt with shelves thereon, whereby each shelf is sized for receiving a deposited container. The device also includes actuator arms for passing electric current into the container in order to identify a specific metallic composition, includes a container crusher, and a hopper for storing the container therein. Further, the device includes a means for dispensing a token to the individual based on the received container. Dewoolfson, however, fails to provide a can counter that includes a pair of opposing, extendable side arms that are capable of being placed over the edges of a trash or recycling container.

Finally, U.S. Pat. No. 5,224,131 to Searfoss provides a device for counting objects placed within a bin. The device includes a shroud that covers a bin and contains a hole through which objects can pass into the bin. Further, a flexible paddle secured to the shroud extends into the hole, whereby the paddle can be flexed when an object is pressed against the paddle and a counter is provided for counting each time the paddle is moved. Although Searfoss discloses a device for counting objects placed within a bin, it fails to provide a pair of extendable and retractable side arms that are designed for placement over a receptacle, thereby enabling use with any existing receptacle.

The present invention provides a means for counting bottles and cans as they are deposited into a receptacle, such as a trash can or recycle bin. The device includes a plate with a circular opening sized for receiving bottles and cans therein. The opening includes a perimeter having a downward projecting wall with a slot extending therethrough, through which an end of an actuator is provided. As objects are placed within the present invention, the object comes into contact with the actuator and pushes the actuator downwards. Thereafter, the movement of the actuator promotes the numerical advancement of the counter on the surface of the device, which provides a means for identifying the amount of bottles and/or cans that have passed by the actuator. Further, the device includes a pair of extendable side arms with hooked distal ends. This enables the device to be placed over a trash receptacle and secured thereover in order to enable use with existing receptacles.

In view of the aforementioned drawbacks of the prior art, it is shown that the present invention is substantially divergent in design elements from the prior art and it is clear that there is a need for an improvement to the existing can and bottle counting devices. In this regard the instant invention substantially fulfills these needs.

### SUMMARY OF THE INVENTION

In view of the foregoing disadvantages inherent in the known types of can counting devices now present in the prior art, the present invention provides a new can counter wherein the same can be utilized for providing convenience for the user when utilization of the counter over an existing receptacle is desired.

It is therefore an object of the present invention to provide a new and improved can and bottle counting device that has all of the advantages of the prior art and none of the disadvantages.

It is another object of the present invention to provide a can and bottle counting device with an object receiving opening, whereby each object placed within the opening is sequentially counted.

Another object of the present invention is to provide a can and bottle counting device that includes extendable and retractable arms that enable placement over existing receptacles.

Yet another object of the present invention is to provide a can and bottle counting device that can be reset when emptying a receptacle or as needed.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 displays a transparent side view of the present invention in use and pop-out views of the counter and reset button.

FIG. 2 displays a side cutaway view of the present invention.

FIG. 3 displays an overhead view of the present invention.

FIG. 4 displays a view of the present invention in use.

### DETAILED DESCRIPTION OF THE INVENTION

Reference is made herein to the attached drawings. Like reference numerals are used throughout the drawings to depict like or similar elements of the can and bottle counting device of the present invention. For the purposes of presenting a brief and clear description of the present invention, the preferred embodiment will be discussed as used for the sequential counting of bottles, cans, and the like within the device. The figures are intended for representative purposes only and should not be considered to be limiting in any respect.

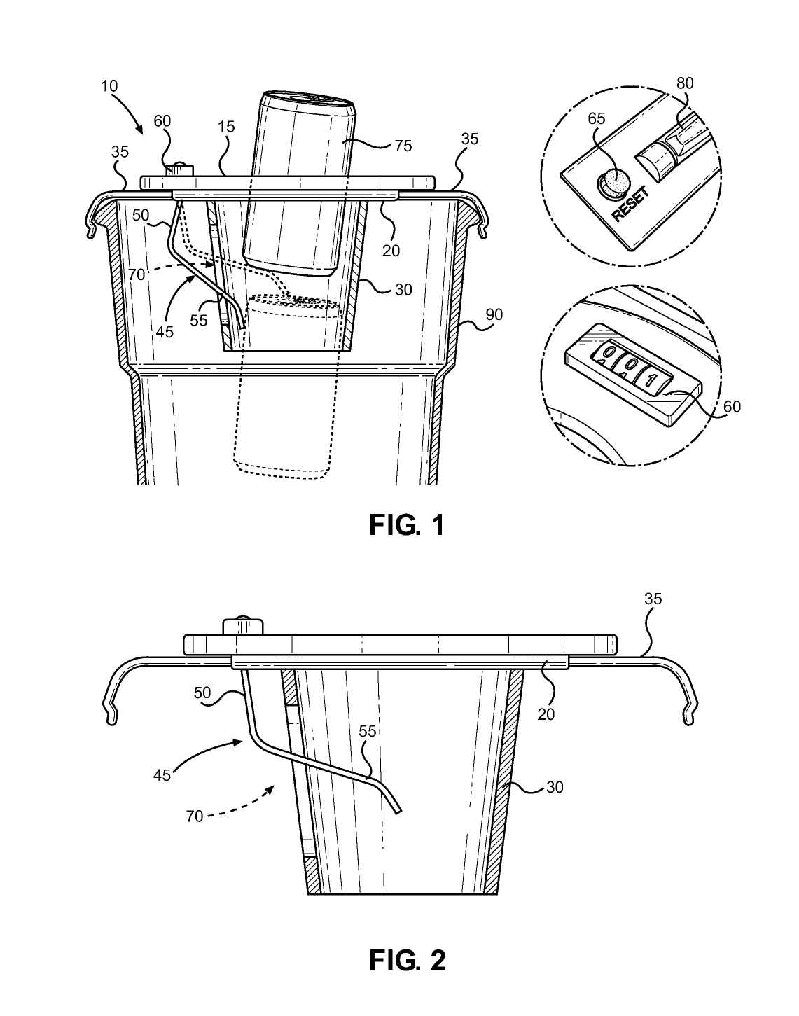

Referring now to FIG. 1, there is shown a transparent side view of the present invention in use and pop-out views of the counter and reset button. The present invention provides a device housing for allowing an individual to sequentially count each bottle, can, or similar object placed into an existing trash or recycling receptacle 90. The device 10 can be removably placed on top a receptacle by a pair of opposed arms 35. The arms 35 are extendable and retractable from a pair of side arm slots 20 located on the underside of the plate 15. Accordingly, the side arm slots 20 include a cylindrical shape with a hollow middle for maintaining the arms 35 therein. The plate 15 of the housing further includes a central opening that extends downward into a sidewall 30, a counting assembly comprising a counter 60 and an actuator 45 that is operatively connected to the counter 60, whereby each object placed through the opening results in the counter 60 advancing sequentially by one digit.

During use, an individual can insert a bottle or can into the opening of the plate 15 in order to place the object into an existing receptacle and numerically record each object that passes through the opening. The actuator 45 comprises an upper end 50 hingedly connected to the counter 60 and a lower end 55 that extends through a slot 70 of the sidewall 30. Further, the actuator is operatively connected to the counter 60. Each item that passes through the opening comes into contact with the second end of the actuator 45 and pushes the second end downward. The actuator 45 is biased towards a first position (dotted lines of FIG. 1), wherein the second end is centrally positioned within the opening. In this way, the second end substantially obstructs the passage of bottles and cans 75 down the sidewall 30. When the second end contacts the bottles and cans 75 that are inserted, the actuator 45 moves into a second position, wherein the second end of the actuator 45 is moved toward the sidewall 30. This allows the bottles and cans 75 within the opening to pass through the opening and out the bottom of the sidewall 30. The downward movement of the second end of the actuator 45 causes the first end to rotate or flex and the operative connection of the actuator 45 to the counter 60 causes the counter 60 to advance one numerical digit, thereby providing an indication of the amount of bottles and/or cans that have passed through the opening.

The bottle and can counter of the present invention can further include a reset button 65 that can return the three-digit counter 60 to zeros. The reset button 65 can be located on the underside of the plate 15 in order to keep it out of the way and to prevent accidental resetting of the recycling count. The button 65, when depressed, can release the three-digits from their current position and allow the digits to each display zeros. This provides convenience for when emptying the receptacle and desiring to restart the counting of objects recycled after insertion through the opening 25 of the device 10. The counter 60 can be digital or analog and can be operable via a power button 80 for controlling the functionality of the counter 60. The power button 80 is adjacent to the reset button 65 on the underside of the plate 15.

Referring now to FIG. 2, there is shown a side cutaway view of the present invention. The present invention includes a generally L-shaped actuator 45 that has an upper end 50 connected to the counter and a lower end 55 that extends through the slot 70 of the sidewall 30. The slot 70 of the side wall 30 is vertical and provides an opening for the actuator 45 to pivot up and down when contacted by a bottle or can passing down the sidewall 30. The pivoting of the actuator 45 causes the counter to advance sequentially forward a single digit with the passing of each object past the actuator 45. Preferably, the sidewall 30 comprises a cylindrical shape that extends downward from the central circular opening 25 of the device, thereby providing a shape that accommodates most bottle and can shapes. In the illustrated embodiment, the sidewall 30 tapers from an upper end to a lower end thereof.

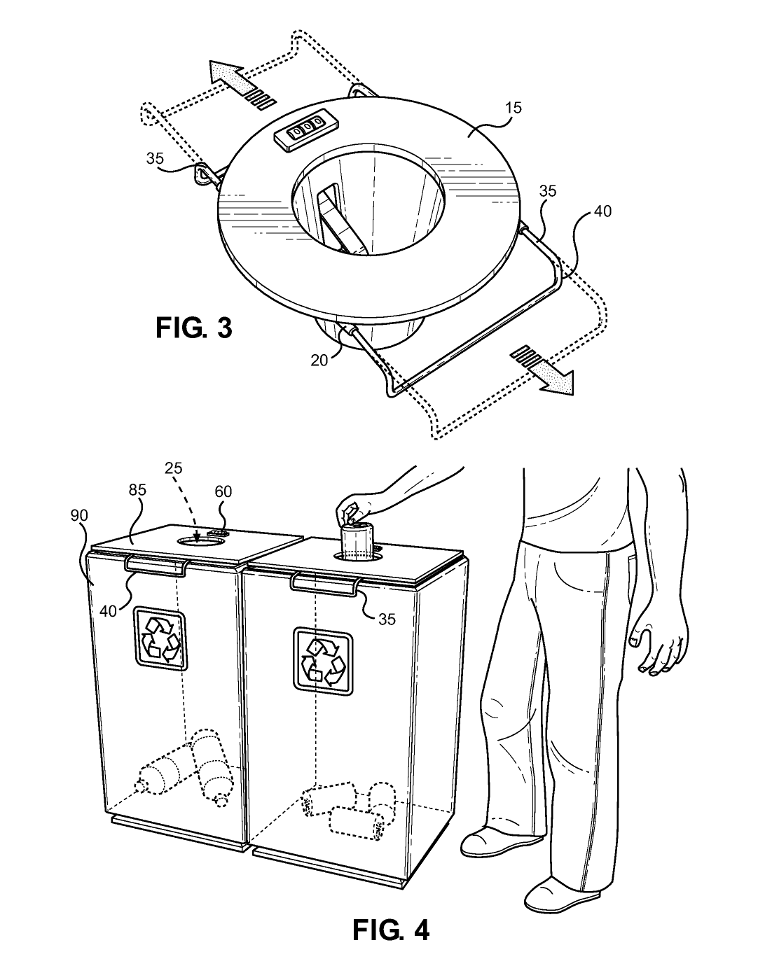

Referring now to FIG. 3, there is shown an overhead view of the present invention. The underside of the plate 15 includes a pair of side arm slots 20 for supporting a pair of opposing arms 35 therein. The arms 35 are generally U-shaped when viewed from the top, and can extend from the side arm slots 20 or retract into the side arm slots 20. In this way, the length of the arms 35 can be adjusted to accommodate containers or receptacles of various sizes. Each of the arms comprises a hooked end 40 so that the present invention can be removably secured on the rim of a container or a receptacle.

Referring now to FIG. 4, there is displayed a view of the present invention in use. The present invention provides a means for counting bottles and cans as they are deposited into a recycling container. The device can be placed onto any existing receptacle 90 by extending or retracting the arms of the device and placing the device over the rim of the receptacle 90, whereby the hooked end 40 can keep the device in place. The device can be utilized in the home, office, public places and the like and can also include a cover 85 thereon that provides a lid for the recycling receptacle 90, thereby providing aesthetic value while also maintaining that only intended objects are deposited into the receptacle. It is contemplated that the cover 85 comprises a cutout that is directly aligned with the opening 25 of the plate and for viewing the counter 60 therethrough.

The present invention can be utilized for keeping count of the amount of recycled bottles and/or cans within a receptacle. This provides convenience for environmental conscious individuals and provides a means for quickly identifying the amount of items delivered to a recycling center. The device provides an advantage over the prior art by enabling an individual to utilize a recycling counter with existing receptacles. This is accomplished by providing a pair of opposing arms that are extendable and retractable in order to provide a means for attachment on a receptacle. Further, the device includes an L-shaped actuator that is operatively connected to a counter 60 at one end and terminates in an end that extends through a slot extending through the sidewall. The actuator, which extends through the sidewall, comes into contact with each object placed within the opening 25 of the plate, whereby each object placed therein pushes the actuator from a first position blocking the passage to a second position. The pivotal movement between the first and second positions causes the counter to advance sequentially forward one unit among the three-digit counter. It is contemplated that after 999 bottles/cans have been counted, the following recycled object may reset the counter. Further, it is under the scope of the present invention to provide a counter which comprises more than three-digits.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A can counting device, comprising:
a housing with a plate with an opening;
a pair of side arms attached to an underside of said plate, wherein said pair of side arms projects outward from said plate in opposing directions;
a counting assembly comprising an actuator that is operably connected to a counter on said plate;
wherein said actuator extends downward from said plate;
wherein said counter advances forward one digit when said actuator moves from a first position to a second position.

2. The can counting device of claim 1, wherein said pair of side arms is adjustable in length.

3. The can counting device of claim 1, wherein each of said pair of side arms is substantially U-shaped.

4. The can counting device of claim 1, wherein each of said pair of side arms comprises a hooked end for securely mounting onto a rim of a receptacle.

5. The can counting device of claim 1, wherein said actuator is substantially L-shaped.

6. The can counting device of claim 1, wherein said counter comprises a multi-digit numerical counter.

7. The can counting device of claim 1, wherein said counting assembly further comprises a reset button;
said reset button disposed on an underside of said plate.

8. The can counting device of claim 1, further comprising a power button for controlling said counter;
said power button disposed on an underside of said plate.

9. The can counting device of claim 1, further comprising a sidewall extending downward from said opening.

10. The can counting device of claim 9, wherein said sidewall comprises a slot that is adapted to allow aid actuator to pass therethrough when moving from said first position to said second position.

11. The can counting device of claim 9, wherein said sidewall tapers from an upper end to a lower end thereof.

12. The can counting device of claim 1, wherein said actuator is centrally positioned within said opening in said first position and said actuator is positioned away from said opening in said second position.

13. The can counting device of claim 1, wherein said actuator moves from said first position to said second position when a can is inserted through said opening.
